(19) United States
(12) Patent Application Publication
(10) Pub. No.: US 2019/0264786 A1
(43) Pub. Date: Aug. 29, 2019

(54) Device for the Angular Positioning of a Shaft

(71) Applicants: Florian Valentin ILE, Judetul Prahova (RO); Aron JINARU, Bucharest (RO)

(72) Inventors: Florian Valentin ILE, Judetul Prahova (RO); Aron JINARU, Bucharest (RO)

(21) Appl. No.: 16/319,414

(22) PCT Filed: Jul. 21, 2017
(86) PCT No.: PCT/RO2017/000014

§ 371 Date: Jan. 21, 2019

(30) Foreign Application Priority Data
Jul. 21, 2016 (LU) 93157

(51) Int. Cl. F16H 25/20; B23Q 5/56; B23Q 1/56; F16H 37/12

(52) U.S. Cl. CPC F16H 25/20; B23Q 5/56; B23Q 1/56; F16H 2025/2053; F16H 37/12; B23Q 2220/004; F16H 25/2003

(57) ABSTRACT

The invention relates to a device for the angular positioning of a shaft, having a computerized command motion controller, two motors with servo drivers and a mechanism with screws and nuts and one crank arm functioning together to lock the positioning output shaft into a fixed position or to rotate it into any direction with zero backlash with variable speed and/or torque.

### FIELD OF THE INVENTION

This invention is inserted in the technical field relative to mechatronics and to mechanical reducers, i.e. to the devices intended to generate mechanical momentum, by varying the modulus and angular speed of electrical motors supervised by computerized controller.

This invention relates to a device for the angular positioning of a shaft, having a computerized command motion controller, two motors with servo drivers and a mechanism with screws and nuts and one crank arm functioning together to lock the positioning output shaft into a fixed position or to rotate it into any direction with zero backlash with variable speed and/or torque, being all a full fused mechatronic device.

### DESCRIPTION OF RELEVANT PRIOR ART

Positioning devices, especially in the machine-tools field, such as rotary axis tables or tool heads and those described herein, are commonly housings that support one or more components. The positioning device enables such components to move in a predetermined way.

In the machine-tools field are most often used computer controlled electrical motor driven reducer mechanism. But it is definitory that mechanism could perform its function of positioning without the electrical part being involved, this having the meaning that a primary mover could be even a human hand applying force on the input shaft.

The wide variety of mechanical speed reducing devices includes pulleys, sprockets, gears, and friction drives. Enclosed-drive speed reducers, also known as gear drives and gearboxes, have two main configurations: in-line and right angle. Each can be achieved using different types of gearing. In-line models are commonly made up of helical or spur gears, planetary gears, cycloidal mechanisms, or harmonic wave generators. Planetary designs generally provide the highest torque in the smallest package. Cycloidal and harmonic drives offer compact designs in higher ratios, while helical and spur reducers are generally the most economical, but with lower gearing ratios.

All are fairly efficient, but also have various level of backlash and possibilities of gearing ratio, but none in a version of no backlash, highest and variable torque. In most cases the maximum torque, speeds, and radial loads cannot be used simultaneously.

Different types of mechanical speed reducers are known, which differ for the configuration and complexity of the couplings between the various members composing them. In general, though, they possess an input and an output, from which a rotation speed lower than that at the input can be drawn as well as a greater mechanical modulus of momentum.

The reducer of simplest type is that composed by a ring gear that engages in a corresponding pinion, with smaller diameter than the ring. Both are fit on corresponding drive shafts; the shaft of the pinion, or input shaft, provides the mechanical momentum to be reduced in speed and increased in modulus, whereas the ring gear shaft, or output shaft, provides the mechanical momentum with increased modulus and reduced rotation speed. The speed reduction ratio is given by the ratio between the number of gears of the pinion and that of the ring gear, and hence substantially by the ratio between the respective circumferences.

A reducer of this type is per se very simple, but in practice it does not supply a high reduction ratio, since the dimensions of the ring gear increase considerably, as does therefore the overall bulk of the reducer.

Another known type of reducer is the so-called worm reducer, in which a toothed wheel is coupled to a shaft whose surface has a high-angle helical thread, whose teeth are called worm teeth. The coupling between the worm and the helical cylindrical ring gear has the object of transferring motion and mechanical momentum between two axes that are orthogonal to each other and do not intersect. The worm or “conductor” is usually the member that transmits the motion to the helical ring gear. The reduction ratio depends on the ratio between the diameters and on the pitch of the worm, i.e. the thread angle.

The disadvantage of such reducer, in addition to that of only operating with axes orthogonal to each other, is that of having low efficiency, and in any case becoming increasingly bulky as the transmission ratio increases.

A further type of simple reducer is that of the epicycloidal reducers in which, for example, a system of one or more gears called “satellite gears”, mounted on a member defined “planet gear”, rotates around a central pinion defined “sun gear”. All of this is placed inside an internally toothed wheel called “ring gear”. The rotation axis of the planet and sun gears coincide. During use, one of the three elements is maintained fixed, while the other two constitute the input and output of the mechanical momentum to be transmitted.

The transmission ratio is given by the number of teeth, but also by which elements constitute the input and output. In general, epicycloidal reducers are not adapted to supply a high transmission ratio, but are considered optimal for transmitting a high mechanical momentum.

Document US2006/060026A1 discloses a system for the angular positioning of a circular gear, comprising two worm gears able to engage the outer diameter of the circular gear, the two worm gears firstly rotating synchronously to rotate the circular gear in the desired angular position and then secondly rotating asynchronously in order to lock the circular gear into position. Document US2006/060026A1 solves only the problem of locking the circular gear into position; it does not solve the problem of the accurate angular positioning because it remains silent on the inherent backlash of the worm gears.

Other types of reducers allow obtaining more advantageous reduction ratios, but always at the cost of considerable bulk and/or considerable structural complexity.

### SUMMARY OF THE INVENTION

The positioning device according to a preferred embodiment of this invention may be a rotary axis positioning for accommodating a CNC machine-tool, a CNC measuring system, a Pan & Tilt system or any other similar component known to those having ordinary skill in the art.

It is definitory that this mechatronic device could not perform its function of positioning only by its mechanical parts without the electrical part being involved, this having the meaning that could not be only one primary mover applying force on an input shaft as in case of pure mechanical reducer devices, but at least two movers on two separated screws and these movers should also be synchronized in motion by a computer controller.

Backlash is defined as the amount by which a tooth space of a gear exceeds a tooth thickness of a mating gear along pitch circles. As a result, there is typically slight relative motion between engaging gears caused by “looseness” between the engaging gears. Backlash thereby creates a difference between actual positional values and “dialed-in” positional values, particularly if the mounted component creates torque, thrust or similar force or if the mounted component creates any dynamic imbalance in the internal mechanicals of the positioning device as in the case of all aforementioned mechanical speed reducers.

Also, backlash reduces the precision, the accuracy and the repeatability of devices based on these kind of mechanical speed reducers and also, by its increasing in time due the high friction between moving members, conduct to an approximation of the positioning and a failure of the presumed controlled manner.

The advantages of the invention are :
providing a super-high precision angular positioning of a shaft
the overall size of the device according to the invention is relatively small;
the manufacturing costs of the device are relatively low.

The invention is based on a systemic approach to demonstrate how to fuse the mechanical, electronic, and microprocessor elements to realize desired functionalities and to bypass the limitations imposed by the utilisation of simpler combination of mechanical speed reducer with computer driven electrical motor.

The abovementioned objects are all achieved by the internal mechanical reducer mechanism with high reduction ratio, object of the present finding, which is characterized as provided for in the below-reported claims. These and other characteristics will be clearer from the following description of the embodiment that is illustrated, as a mere non-limiting example, in the enclosed set of drawing tables where FIGS. 1-6 illustrate an embodiment of the present device, in accordance with corresponding dimetric view of the device.

The device for the angular positioning of a shaft according to the invention comprises a controller, a first and a second driving means controlled by the controller, the first driving means being capable to drive a first driving screw and the second driving means being capable to drive a second driving screw; the first and the second driving screws having their respective longitudinal axes arranged at a 90° angle relative to each other; a first support element capable to shift in the direction of the longitudinal axis of the first driving screw upon driving the first driving screw by the first driving means; a second support element capable to shift in the direction of the longitudinal axis of the second driving screw upon the driving of the second driving screw by the second driving means; a first straight rail guide rigidly fixed on the first support element, and arranged at a 90° angle relative to the longitudinal axis of the first driving screw and parallel to the longitudinal axis of the second driving screw; a second straight rail guide rigidly fixed on the second support element , and arranged at a 90° angle relative to the longitudinal axis of the second driving screw, and parallel to the longitudinal axis of the first driving screw; a first block mounted on the first straight rail guide in such a manner that it allows a relative movement between the first block and the first straight rail guide, along at least a portion of the first straight rail guide, upon driving the first and/or the second driving screw; a second block mounted on the second straight rail guide in such a manner that it allows a relative movement between the second block and the second straight rail guide, along at least a portion of the second straight rail guide, upon driving the first and/or the second driving screw; a motion imparting assembly capable to move along a path resulting from the movement of the first and/or second straight rail guides; a circular transfer disc that is parallel to the first and second driving screws, and is also parallel to the first and second straight rail guides, and is provided with a third straight rail guide arranged along the direction of a radius of the transfer disc; the transfer disc being capable to rotate, upon the movement of the motion imparting assembly, along a rotation axis perpendicular on the transfer disc and passing through the centre of the transfer disc; a shaft fixed to the transfer disc, such that the longitudinal axis of the shaft and the rotation axis of the transfer disc are the same.

In a first preferred embodiment, the longitudinal axis of the first and second driving screws lie in the same plane, the first and second support elements have each a substantially plane surface on which is fixed the first straight rail guide and the second straight rail guide, respectively; a first end of the first support element is connected to a first end of the second support element in a connection zone; the motion imparting assembly comprises: —a pin fixed, at one of its ends, to the connection zone of the first and second support elements and perpendicular on both first and second straight rail guides; —a bearing inside which the pin is at least partly accommodated, —a carriage rigidly fixed to the bearing;
the carriage being capable to slide along the third straight rail guide that is fixed on the circular transfer disc.

In the first preferred embodiment the bearing may be a ball bearing, or a roller bearing or a needle bearing.

In the first preferred embodiment, a second end of the first support element is connected to a second end of the second support element by means of a reinforcing element.

In the first preferred embodiment, the reinforcing element may have the shape of a circular arc, or a circular sector, or a bar, or a triangle.

In a second preferred embodiment, the longitudinal axis of the first and second driving screws lie in different planes; the first and second support elements have each a substantially plane surface on which is fixed the first straight rail guide and the second straight rail guide, respectively; the motion imparting assembly comprises: —a first bearing rigidly fixed to the first block; —a second bearing rigidly fixed to the second block; —a pin perpendicular on both first and second straight rail guides at least partly accommodated inside the first and second bearings; —a carriage rigidly fixed to one end of the pin;
the carriage being capable to slide along the third straight rail guide that is fixed on the circular transfer disc.

In all embodiments, the first driving means comprises a first electrical motor driven by a first servo driver and the second driving means comprises a second electrical motor driven by a second servo driver.

In all embodiments, the device further comprises: —means for generating analog electrical signals to be transmitted to the controller and related to the angular position of the shaft; and —a rotary encoder for generating digital signals to be transmitted to the controller and related to the angular position of the shaft.

The means for generating analog electrical signals comprise three coils, the first and second coils being fixed in a crossing position at a 90° angle relative to each other and the third coil being capable to rotate together with the shaft to generate a phase variation of electrical current related to the angular position of the shaft into the first and second coils, all three coils having separate and opposed north-south poles.

The controller is capable to run an interpolation algorithm to command the first servo driver and the second servo driver.

An analogical electrical continuous signal, obtained through the variation of the phases of the electrical currents from said coils, is capable to command the first servo driver and the second servo driver in-phase or in phase-difference according to the position of the shaft inside the four quadrants of its axis in such a manner to control the speed and direction of the rotation of the shaft.

Preferably, the device according to the invention is accommodated inside a housing.

The shaft is fitted on a bearing fixed in the housing.

### BRIEF DESCRIPTION OF THE DRAWINGS

FIG. 1 is a perspective dimetric view of the first embodiment of the device according to the invention;

FIG. 2 is atop view of the positioning device shown in FIG. 1 in a specific angular position and generating high torque;

FIG. 3 is a top view of the positioning device shown in FIG. 1 in specific angular position and generating low torque;

FIG. 4 is a top view of the positioning device shown in FIG. 1 in specific angular position at 90° relative to FIG.2 and generating high torque;

FIG. 5 is a top view of the second embodiment of the device according to the invention;

FIG. 6 is a sectional view of the device shown in FIG. 5.

### DESCRIPTION OF PREFERRED EMBODIMENTS

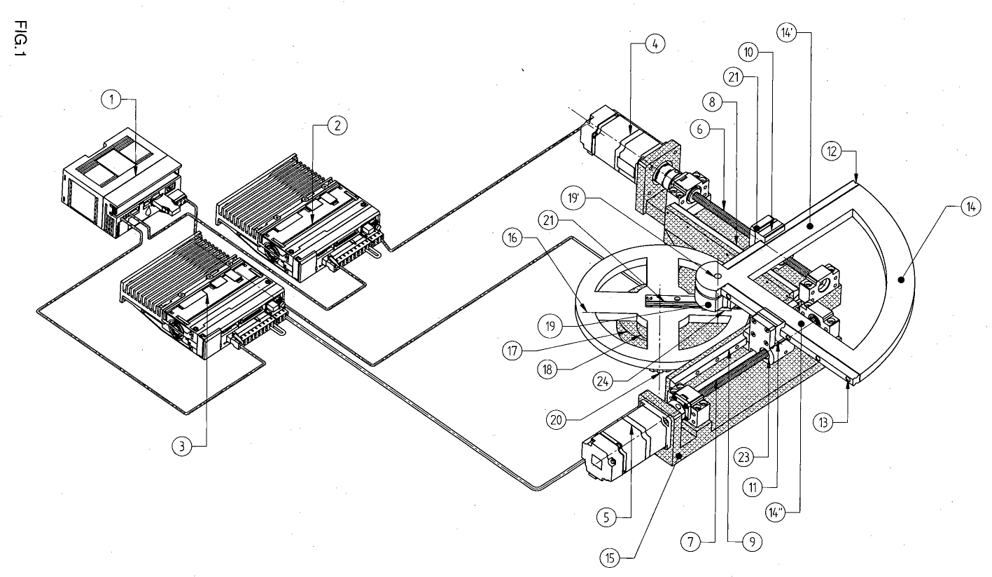

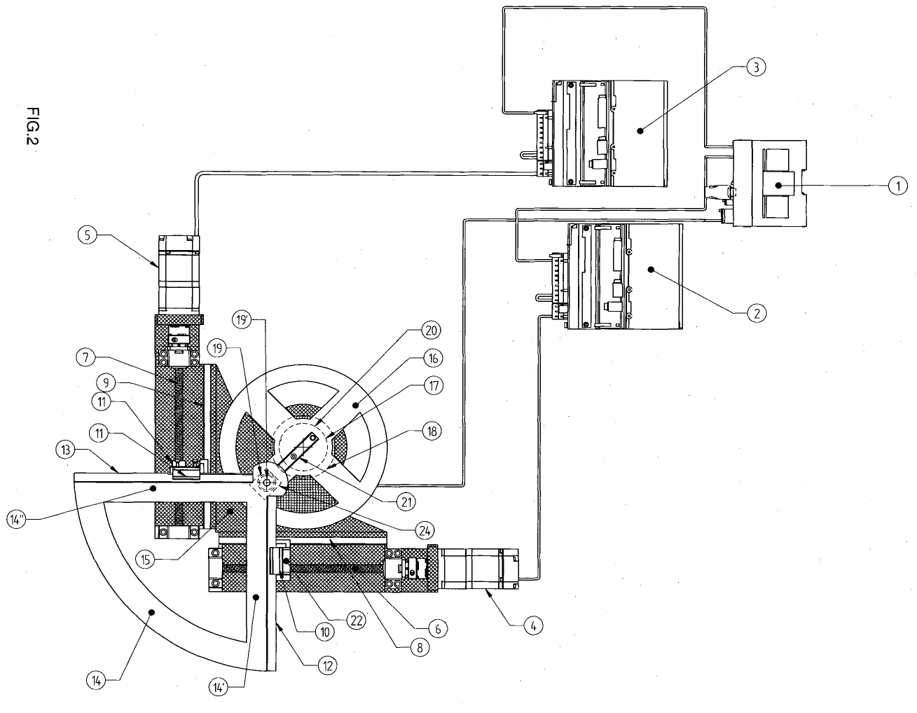

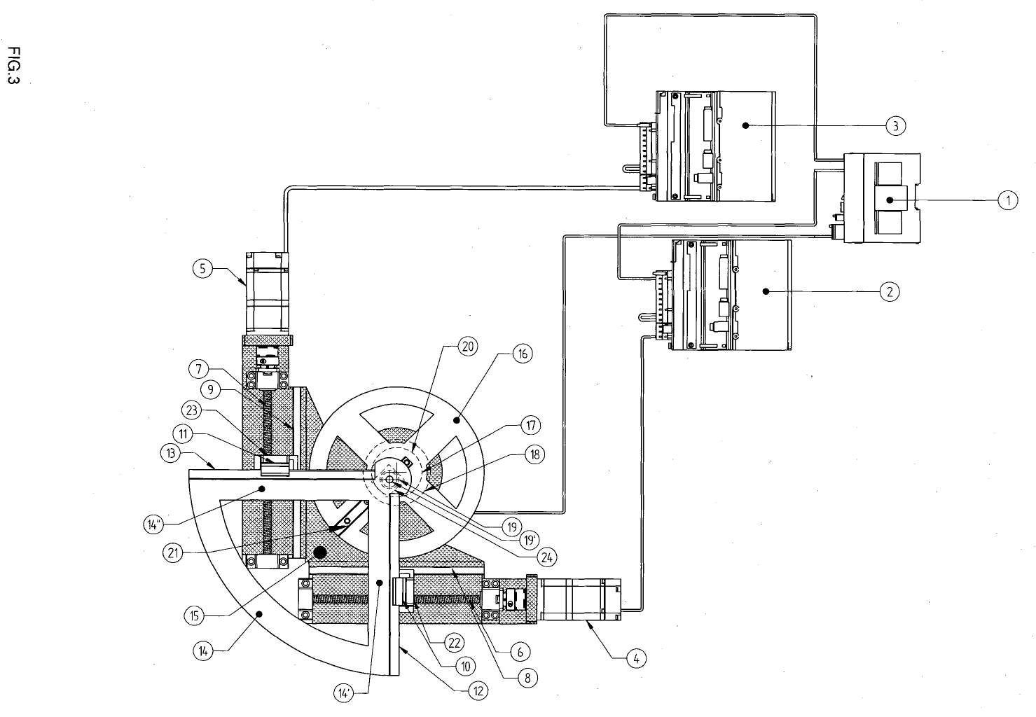

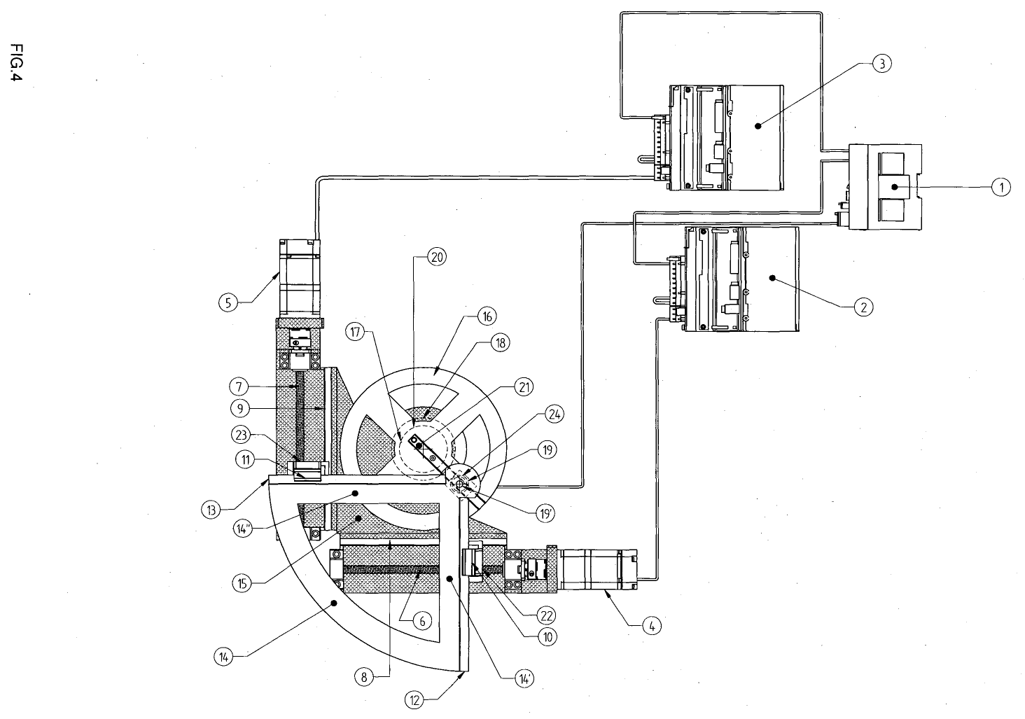

According to a preferred embodiment of this invention, an angular positioning generator device, such as on a rotary table or rotary head having a range of motion around an axis is adaptable for use in connection with any number of components. Components may include angular positioning systems, CNC machine tools, CNC measurement machines, surveillance systems, such as cameras, and positioning and/or guidance systems, such as lasers. FIGS. 1-6 show various features on the preferred embodiment of the subject invention.

The positioning device is preferably accommodated inside a housing 15. The housing 15 is preferably constructed of structural materials that provide maximum torsional rigidity. In addition, the housing is preferably powder-coated and corrosion and weather resistant. In particular, the housing 15 is preferably capable of withstanding wet and otherwise corrosive environments; high (+80° C.) and/or low (−30° C.) temperature environments; may operate in high humidity and/or any other possible environment suitable for the angular positioning device such as disclosed herein. The housing 15 may include one or more removable sidewalls (not figured due the specifics of each embodiment) which are removably attached to the housing 15 to facilitate access and/or maintenance to the mechanical internals, as described in detail below.

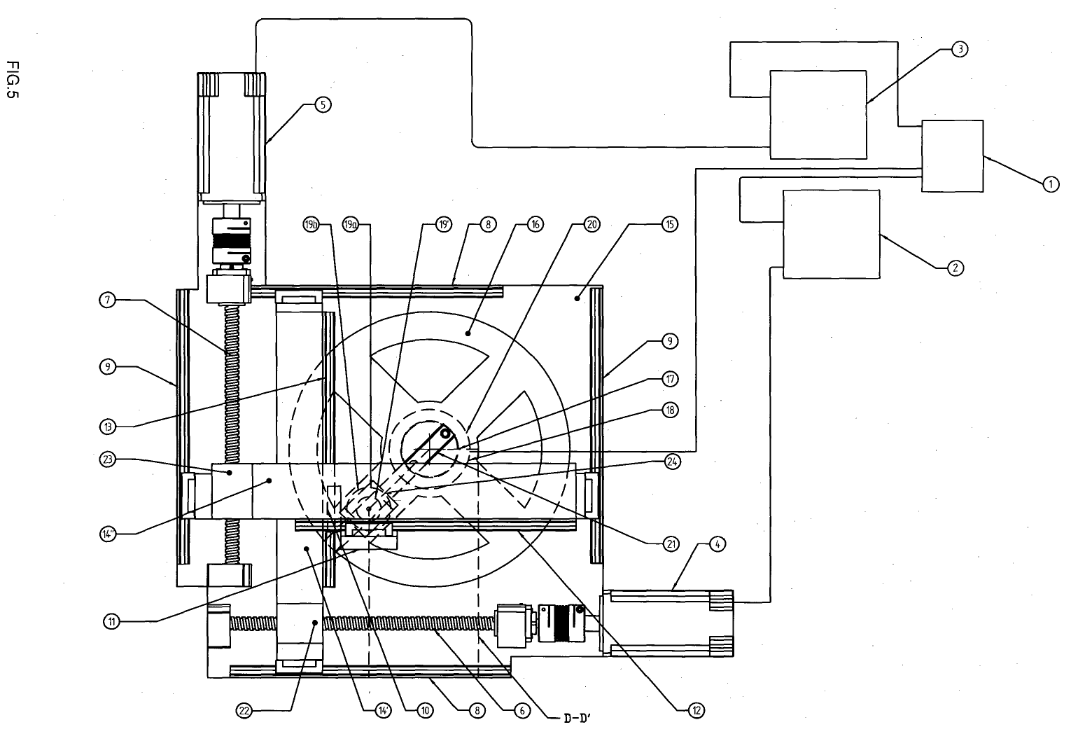

The device for the angular positioning of a shaft, as shown in FIGS. 1 and 5, comprises:
a controller 1
a first and a second driving means controlled by the controller 1, the first driving means being capable to drive a first driving screw 6 and the second driving means being capable to drive a second driving screw 7
   the first 6 and the second 7 driving screws having their respective longitudinal axes arranged at a 90° angle relative to each other
a first support element 14′ capable to shift in the direction of the longitudinal axis of the first driving screw 6 upon driving the first driving screw 6 by the first driving means
a second support element 14″ capable to shift in the direction of the longitudinal axis of the second driving screw 7 upon the driving of the second driving screw 7 by the second driving means
a first straight rail guide 12 rigidly fixed on the first support element 14′, and arranged at a 90° angle relative to the longitudinal axis of the first driving screw 6 and parallel to the longitudinal axis of the second driving screw 7
a second straight rail guide 13 rigidly fixed on the second support element 14″, and arranged at a 90° angle relative to the longitudinal axis of the second driving screw 7, and parallel to the longitudinal axis of the first driving screw 6
a first block 10 mounted on the first straight rail guide 12 in such a manner that it allows a relative movement between the first block 10 and the first straight rail guide 12, along at least a portion of the first straight rail guide 12, upon driving the first 6 and/or the second driving screw 7
a second block 11 mounted on the second straight rail guide 13 in such a manner that it allows a relative movement between the second block 11 and the second straight rail guide 13, along at least a portion of the second straight rail guide 13, upon driving the first 6 and/or the second driving screw 7
a motion imparting assembly capable to move along a path resulting from the movement of the first 12 and/or second 13 straight rail guides
a circular transfer disc 16 that is parallel to the first 6 and second 7 driving screws, and is also parallel to the first 12 and second 13 straight rail guides, and is provided with a third straight rail guide 21 arranged along the direction of a radius of the transfer disc 16
   the transfer disc 16 being capable to rotate, upon the movement of the motion imparting assembly, along a rotation axis perpendicular on the transfer disc 16 and passing through the centre of the transfer disc 16
a shaft 20 fixed to the transfer disc 16, such that the longitudinal axis of the shaft 20 and the rotation axis of the transfer disc 16 are the same.

The device preferably further comprises linear rail guides 8 and 9 on adjacently sides of the housing. The purpose of said linear rail guides 8 and 9 is to maintain the straightness of the axes of the first 6 and second 7 driving screws and, in case the screws are relatively long, to prevent the whipping of the screws.

As shown in FIGS. 1-4, corresponding to the first embodiment of the device according to the invention:
the longitudinal axis of the first 6 and second 7 driving screws lie in the same plane
the first 14′ and second 14″ support elements have each a substantially plane surface on which is fixed the first straight rail guide 12 and the second straight rail guide 13, respectively
a first end of the first support element 14′ is connected to a first end of the second support element 14″ in a connection zone
the motion imparting assembly comprises:
   a pin 19′ fixed, at one of its ends, to the connection zone of the first 14′ and second 14″ support elements and perpendicular on both first 12 and second 13 straight rail guides
   a bearing 19 inside which the pin 19′ is at least partly accommodated,
   a carriage 24 rigidly fixed to the bearing 19
the carriage 24 being capable to slide along the third straight rail guide 21 that is fixed on the circular transfer disc 16.

The bearing 19 is a ball bearing, or a roller bearing or a needle bearing.

A second end of the first support element 14′ is connected to a second end of the second support element 14″ by means of a reinforcing element.

The reinforcing element has the shape of a circular arc but can also be a circular sector, or a bar, ora triangle.

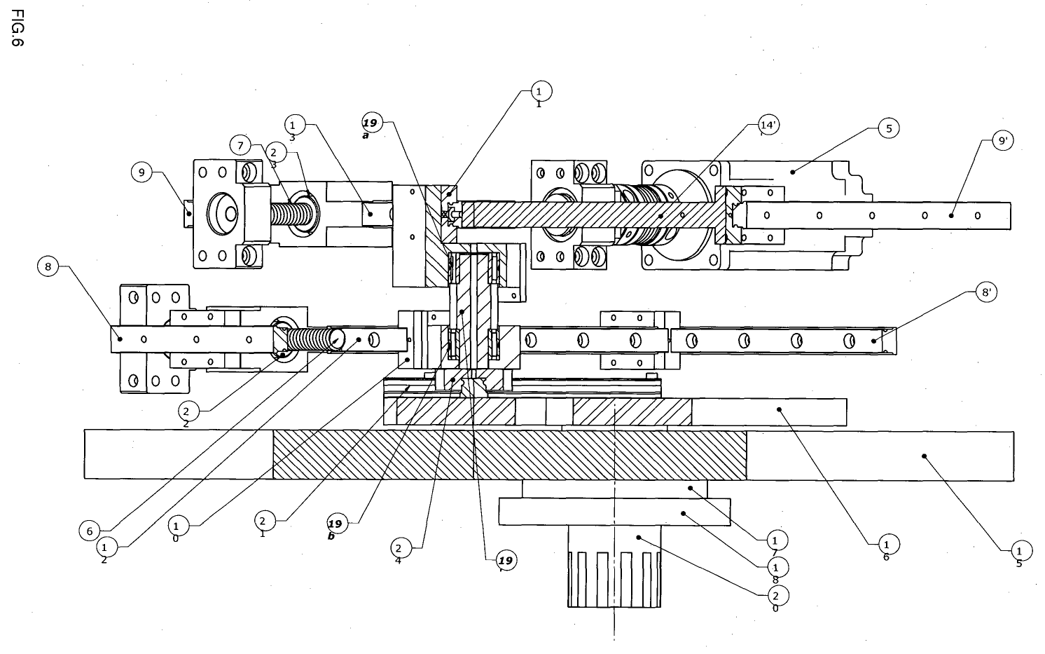

As shown in FIGS. 5-6, corresponding to the second embodiment of the device according to the invention:
the longitudinal axis of the first 6 and second 7 driving screws lie in different planes
the first 14′ and second 14″ support elements have each a substantially plane surface on which is fixed the first straight rail guide 12 and the second straight rail guide 13, respectively
the motion imparting assembly comprises:
   a first bearing 19a rigidly fixed to the first block 10
   a second bearing 19b rigidly fixed to the second block 11
   a pin 19′ perpendicular on both first 12 and second 13 straight rail guides at least partly accommodated inside the first 19a and second 19b bearings
   a carriage 24 rigidly fixed to one end of the pin 19′
the carriage 24 being capable to slide along the third straight rail guide 21 that is fixed on the circular transfer disc 16.

In all embodiments (but represented only in FIGS. 1-5), the first driving means comprises a first electrical motor 4 driven by a first servo driver 2 and the second driving means comprises a second electrical motor 5 driven by a second servo driver 3.

In all embodiments, the device further comprises means 17 for generating analog electrical signals to be transmitted to the controller 1 and related to the angular position of the shaft 20 and a rotary encoder 18 for generating digital signals to be transmitted to the controller 1 and related to the angular position of the shaft 20.

Said means for generating analog electrical signals comprise three coils, the first and second coils being fixed in a crossing position at a 90° angle relative to each other and the third coil being capable to rotate together with the shaft 20 to generate a phase variation of electrical current related to the angular position of the shaft 20 into the first and second coils, all three coils having separate and opposed north-south poles.

In all embodiments, the controller 1 is capable to run an interpolation algorithm to command the first servo driver 2 and the second servo driver 3.

An analogical electrical continuous signal, obtained through the variation of the phases of the electrical currents from said coils, is capable to command the first servo driver 2 and the second servo driver 3 in-phase or in phase-difference according to the position of the shaft 20 inside the four quadrants of its axis in such a manner to control the speed and direction of the rotation of the shaft 20.

The shaft 20 is fitted on a bearing fixed in the housing 15.

The torque of motors 4, 5 is transformed by the screws 6 and 7 in thrust by a ratio provided by the thread with a specific pitch and lead and are pulling and/or pushing at the same time both support elements 14′, 14″ accordingly.

The crank arm formed by the support elements 14′, 14″, the motion imparting assembly and the transfer disc 16 with an output shaft 20 transform again the amplified thrust into torque with a ratio between the length of the crank arm and the diameter of the output shaft.

Backlash is removed from the positioning device by the acting motors 4 and 5 on both axis of the device (i.e. longitudinal axis of the screws 6 and 7, respectively) relative to the support elements 14′, 14″ with the crank arm based on the motion imparting assembly leveraging the output shaft 20 and according to the dialed-in position generated by the interpolation algorithm acting as an interlocking of the two axis due to the mathematical inaccuracy of each point on the interpolated circle.

Some applications may require the precise angular positioning of a plurality of shafts, so in order to solve this issue one can imagine a system provided with a plurality of devices according to the invention.

While in the foregoing specification this invention has been described in relation to certain preferred embodiments thereof, and many details have been set forth for purpose of illustration, it will be apparent to those skilled in the art that the device according to this invention is susceptible to additional embodiments and that certain of the details described herein can be varied considerably without departing from the basic principles of the invention.

1. Device for the angular positioning of a shaft, comprising:
a controller (1)
a first and a second driving means controlled by the controller (1), the first driving means being capable to drive a first driving screw (6) and the second driving means being capable to drive a second driving screw (7)
the first (6) and the second (7) driving screws having their respective longitudinal axes arranged at a 90° angle relative to each other
a first support element (14′) capable to shift in the direction of the longitudinal axis of the first driving screw (6) upon driving the first driving screw (6) by the first driving means
a second support element (14″) capable to shift in the direction of the longitudinal axis of the second driving screw (7) upon the driving of the second driving screw (7) by the second driving means
characterized in that the device further comprises:
a first straight rail guide (12) rigidly fixed on the first support element (14′), and arranged at a 90° angle relative to the longitudinal axis of the first driving screw (6) and parallel to the longitudinal axis of the second driving screw (7)
a second straight rail guide (13) rigidly fixed on the second support element (14″), and arranged at a 90° angle relative to the longitudinal axis of the second driving screw (7), and parallel to the longitudinal axis of the first driving screw (6)
a first block (10) mounted on the first straight rail guide (12) in such a manner that it allows a relative movement between the first block (10) and the first straight rail guide (12), along at least a portion of the first straight rail guide (12), upon driving the first (6) and/or the second driving screw (7)
a second block (11) mounted on the second straight rail guide (13) in such a manner that it allows a relative movement between the second block (11) and the second straight rail guide (13), along at least a portion of the second straight rail guide (13), upon driving the first (6) and/or the second driving screw (7)
a motion imparting assembly capable to move along a path resulting from the movement of the first (12) and/or second (13) straight rail guides
a circular transfer disc (16) that is parallel to the first (6) and second (7) driving screws, and is also parallel to the first (12) and second (13) straight rail guides, and is provided with a third straight rail guide (21) arranged along the direction of a radius of the transfer disc (16)
the transfer disc (16) being capable to rotate, upon the movement of the motion imparting assembly, along a rotation axis perpendicular on the transfer disc (16) and passing through the center of the transfer disc (16)
a shaft (20) fixed to the transfer disc (16), such that the longitudinal axis of the shaft (20) and the rotation axis of the transfer disc (16) are the same.

2. Device according to claim 1, wherein:
the longitudinal axis of the first (6) and second (7) driving screws lie in the same plane
the first (14′) and second (14″) support elements have each a substantially plane surface on which is fixed the first straight rail guide (12) and the second straight rail guide (13), respectively
a first end of the first support element (14′) is connected to a first end of the second support element (14″) in a connection zone
the motion imparting assembly comprises:
a pin (19′) fixed, at one of its ends, to the connection zone of the first (14′) and second (14″) support elements and perpendicular on both first (12) and second (13) straight rail guides
a bearing (19) inside which the pin (19′) is at least partly accommodated,
a carriage (24) rigidly fixed to the bearing (19)
the carriage (24) being capable to slide along the third straight rail guide (21) that is fixed on the circular transfer disc (16).

3. Device according to claim 2, wherein the bearing (19) is a ball bearing, or a roller bearing or a needle bearing.

4. Device according to claim 2, wherein a second end of the first support element (14′) is connected to a second end of the second support element (14″) by means of a reinforcing element.

5. Device according to claim 4, wherein the reinforcing element has the shape of a circular arc, or a circular sector, or a bar, or a triangle.

6. Device according to claim 1, wherein:
the longitudinal axis of the first (6) and second (7) driving screws lie in different planes
the first (14′) and second (14″) support elements have each a substantially plane surface on which is fixed the first straight rail guide (12) and the second straight rail guide (13), respectively
the motion imparting assembly comprises:
a first bearing (19a) rigidly fixed to the first block (10)
a second bearing (19b) rigidly fixed to the second block (11)
a pin (19′) perpendicular on both first (12) and second (13) straight rail guides at least partly ccommodated inside the first (19a) and second (19b) bearings
a carriage (24) rigidly fixed to one end of the pin (19′)
the carriage (24) being capable to slide along the third straight rail guide (21) that is fixed on the circular transfer disc (16).

7. Device according to claim 1, wherein the first driving means comprises a first electrical motor (4) driven by a first servo driver (2) and the second driving means comprises a second electrical motor (5) driven by a second servo driver (3).

8. Device according to claim 1, further comprising:
means (17) for generating analog electrical signals to be transmitted to the controller (1) and related to the angular position of the shaft (20);
a rotary encoder (18) for generating digital signals to be transmitted to the controller (1) and related to the angular position of the shaft (20).

9. Device according to claim 8, wherein said means for generating analog electrical signals comprise three coils, the first and second coils being fixed in a crossing position at a 90° angle relative to each other and the third coil being capable to rotate together with the shaft (20) to generate a phase variation of electrical current related to the angular position of the shaft (20) into the first and second coils, all three coils having separate and opposed north-south poles.

10. Device according to claim 1, wherein the controller (1) is capable to run an interpolation algorithm to command the first servo driver (2) and the second servo driver (3).

11. Device according to claim 9, wherein an analogical electrical continuous signal, obtained through the variation of the phases of the electrical currents from said coils, is capable to command the first servo driver (2) and the second servo driver (3) in-phase or in phase-difference according to the position of the shaft (20) inside the four quadrants of its axis in such a manner to control the speed and direction of the rotation of the shaft (20).

12. Device according to claim 1, wherein the device is accommodated inside a housing (15).

13. Device according to claim 1, wherein the shaft (20) is fitted on a bearing fixed in the housing (15).

14. Positioning system provided with at least one device according to claim 1.
